(19) United States
(12) Patent Application Publication
(10) Pub. No.: US 2021/0132794 A1
(43) Pub. Date: May 6, 2021

(54) SYSTEMS, APPARATUS, AND METHODS FOR OVERLAYING A TOUCH PANEL WITH A PRECISION TOUCH PAD

(71) Applicant: LENOVO (Singapore) PTE. LTD., New Tech Park (SG)

(72) Inventors: Yuichi Shigematsu, Yokohama-shi (JP); Seiichi Kawano, Yokohama-shi (JP); Ryohta Nomura, Yokohama-shi (JP); Yoshitsugu Suzuki, Yokohama-shi (JP)

(21) Appl. No.: 17/088,800

(22) Filed: Nov. 4, 2020

(30) Foreign Application Priority Data
Nov. 6, 2019 (JP) 2019-201437

(51) Int. Cl. G06F 3/0488; G06F 3/0354

(52) U.S. Cl. CPC G06F 3/04886; G06F 2203/04803; G06F 3/03547

(57) ABSTRACT

Methods, systems, and apparatus that overlay a touch panel with a precision touch pad are disclosed. One method includes detecting, by a processor of an information handling device, a touch position of a touch on a display unit, generating a touch panel area where the touch panel is formed, a second area that is not controlled by an operating system and that is overlaid on a first area of a touch screen controlled by the operating system according to a predetermined operation, and generating a signal indicating that a precision touch pad is touched in response to the second area being touched. Apparatus and computer program products for performing the method are also disclosed.

### REFERENCE TO RELATED APPLICATION

This application claims priority to Japanese Patent Application No. JP2019-201437, filed on Nov. 6, 2019, the contents of which are incorporated herein by reference, in their entirety.

### FIELD

The subject matter disclosed herein relates to computing systems and devices and, more particularly, relates to systems, apparatus, and methods for overlaying a touch panel with a precision touch pad.

### BACKGROUND

Conventional terminals (e.g., tablet terminals) that display a virtual touch pad (which may also be referred to as a, “virtual touch pad”) in a predetermined area on a touch screen have been proposed. A user can operate a mouse cursor, for example, with a touch operation on the virtual touch pad. For example, Japanese Unexamined Patent Application Publication No. 2014-241139 discloses a technique for displaying a user interface of an operating system and a virtual touch pad on a touch screen to control the operation of a mouse cursor based on a user's touch operation on the virtual touch pad. The technique disclosed in Japanese Unexamined Patent Application Publication No. 2014-241139 cannot perform various gesture operations other than the operation of a mouse cursor, which limits the functionality of the virtual touch pad on the touch screen.

### BRIEF SUMMARY

Various embodiments provide apparatuses for overlaying a touch panel with a precision touch pad. One apparatus includes a display unit, a touch panel configured to detect a touch position of a touch on the display unit, and an information handling device. The information handling device is configured to generate, in a touch panel area where the touch panel is formed, a second area that not controlled by an operating system and that is overlaid on a first area of a touch screen controlled by the operating system according to a predetermined operation and generate a signal indicating that a precision touch pad is touched in response to the second area being touched.

Methods for overlaying a touch panel with a precision touch pad are also disclosed herein. One method includes detecting, by a processor of an information handling device, a touch position of a touch on a display unit, generating a touch panel area where the touch panel is formed, a second area that is not controlled by an operating system and that is overlaid on a first area of a touch screen controlled by the operating system according to a predetermined operation, and generating a signal indicating that a precision touch pad is touched in response to the second area being touched.

Other embodiments provide computer program products for overlaying a touch panel with a precision touch pad. One computer program product includes a computer-readable storage medium including program instructions embodied therewith in which the program instructions are executable by a processor to cause the processor to detect a touch position of a touch on a display unit, generate a touch panel area where the touch panel is formed, a second area that is not controlled by an operating system and that is overlaid on a first area of a touch screen controlled by the operating system according to a predetermined operation, and generate a signal indicating that a precision touch pad is touched in response to the second area being touched.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a diagram illustrating one embodiment of an information processing apparatus (e.g., an information handling device) including display with a touchscreen;

FIG. 2 is a diagram illustrating one embodiment of the display and touch screen of FIG. 1 in a plurality of modes;

FIG. 3 is a diagram illustrating an embodiment of a set of functions for the touch screen in FIGS. 1 and 2 in each mode;

FIG. 4 is a diagram illustrating one embodiment of a hardware configuration of the information processing apparatus of FIG. 1;

FIG. 5 is a block diagram illustrating one embodiment of the functional configuration of the information processing apparatus of FIG. 1;

FIG. 6 is a flow diagram illustrating one embodiment of a process performed by the information processing apparatus of FIG. 1;

FIG. 7 is a diagram illustrating one embodiment of the display and function of the touch screen at start-up;

FIG. 8 is a diagram illustrating one embodiment of the display and a set of functions for the touch screen during the display of a screen keyboard.

FIG. 9 is a diagram illustrating one embodiment of the display and a set of functions of the touch screen during the display of a toolbar;

FIG. 10 is a diagram illustrating one embodiment of the display and a set of functions for the touch screen during the display of a virtual touch pad;

FIG. 11 is a flowchart illustrating one embodiment of processing performed in a second control unit;

FIG. 12 is a diagram illustrating one embodiment of the display and a set of functions for a first modification of the touch screen; and

FIG. 13 is a diagram illustrating one embodiment of the display and a set of functions for a second modification of the touch screen.

### DETAILED DESCRIPTION

As will be appreciated by one skilled in the art, aspects of the embodiments may be embodied as an apparatus and/or a system. Accordingly, embodiments may take the form of an entirely hardware embodiment or an embodiment combining hardware and software aspects that may all generally be referred to herein as a “circuit,” “module” or “system.”

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “including,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding Figures. Like numbers refer to like elements in all Figures, including alternate embodiments of like elements.

The present technology solves at least some of the issues discussed above in the Background section. Specifically, the various embodiments disclosed herein provide various gesture operations performed on a touch pad, such as multi-touch screen scroll operations and zoom-in or zoom-out operations. That is, various embodiments are able to perform various gesture operations using the virtual touch pad in addition to the operation of the mouse cursor to improve user experiences with a touch screen.

To solve at least some issues with conventional computing device/systems, an information processing apparatus according to various embodiments includes a display unit, a touch panel configured to detect the touch position of a touch on the display unit, and firmware configured to generate, in a touch panel area in which the touch panel is formed, a second area that not directly controlled by an operating system and which is overlaid on a first area as a touch screen directly controlled by the operating system according to a predetermined operation, and to generate a signal indicating that a touch pad is touched when the second area is touched.

The information processing apparatus may also include a storage unit configured to store definition information including hardware information related to the touch screen and the touch pad is different from the touch screen and in which the firmware generates a signal including a definition corresponding to an area in which the touch position is detected and outputs the signal to the operating system.

The information processing apparatus may further be such that, in response to the touch position being detected in the first area, the firmware generates a first signal including the definition of the touch screen and outputs the first signal to the operating system, while in response to the touch position being detected in the second area, the firmware generates a second signal including the definition of the touch pad and outputs the second signal to the operating system.

The information processing apparatus may further include a function control unit in which the function control unit performs a set of controls to set, based on a user operation, a first mode that sets the first area in the touch panel area or a second mode that sets the first area and the second area in the touch panel area.

The information processing apparatus may further include a display processing unit that, in response to the second mode being set, the display processing unit displays a virtual precision touch pad, as a virtual type of the touch pad, on the display unit based on the definition and the firmware generates the second area in an area in which the virtual touch pad is displayed.

The information processing apparatus may further be such that, based on the definition, the display processing unit controls a display layout of a screen keyboard displayed in the first area and the virtual touch pad displayed in the second area.

The information processing apparatus may be such that the display processing unit displays the virtual precision touch pad in a manner to be overlaid on the screen keyboard. The information processing apparatus may also be such that the display processing unit displays the virtual precision touch pad without being overlaid on the screen keyboard.

An information processing method according to various embodiments includes causing a touch panel to detect the touch position of a touch on a display unit and causing firmware to generate, in a touch panel area in which the touch panel is formed, a second area that is not directly controlled by an operating system and which is overlaid on a first area as a touch screen directly controlled by the operating system according to a predetermined operation and to generate a signal indicating that of a touch pad is touched in response to the second area being touched.

The various embodiments discussed herein can improve user experiences with a touch screen. Specifically, various embodiments provide an information processing apparatus that causes a touch screen to function as at least a touch screen or a precision touch pad (PTP). The precision touch pad virtually displayed on a touch screen is also called a virtual precision touch pad (VPTP).

The touch screen according to various embodiments includes an input/output device including a display screen capable of displaying various kinds of information and a touch panel capable of detecting touch operations. A user can perform an operation by directly touching an operation target displayed on the touch screen. For example, the user can directly touch each key on a screen keyboard (e.g., an On Screen Keyboard (OSK)) displayed on the touch screen to perform a set of keyboard inputs.

The PTP according to various embodiments includes a touch pad that allows/enables gesture operations. On the PTP, various gesture operations can also be performed in addition to the operation of a mouse cursor. For example, the screen is scrolled in response to a gesture that touches the surface of the PTP with two fingers and slides the two fingers in a direction parallel to the surface is performed. Further, the display of a window or the display of an application is switched in response to a gesture that touches the surface of the PTP with three fingers and swipes the three fingers to the right or left. Further, the display is zoomed out or in on display in response to a gesture that touches the surface of the PTP with two fingers and pinches out or in the surface. Note that the number of fingers with which the PTP is touched and the types of gestures in the gesture operations are not limited to the above examples. The combinations of the number of fingers and the types of gestures are also not limited to those in the above examples.

The information processing apparatus according to various embodiments can be realized by a terminal including at least a touch screen. For example, the information processing apparatus may be realized by a terminal including a touch screen, such as a laptop personal computer (PC), a tablet terminal, or a smartphone, among other computing devices/systems that are possible and contemplated herein. The information processing apparatus may also be realized by a foldable terminal (e.g., a foldable device) capable of folding the touch screen. Note that the terminals that realize the information processing apparatus are not limited to the above examples.

Further, the number of touch screens of the information processing apparatus is not limited to any particular quantity. For example, the information processing apparatus may include two displays (e.g., a dual display type) in which one of the two displays is a touch screen or both displays are touch screens. In the following description, an embodiment in which the information processing apparatus is a laptop PC including two touch screens will be taken as an example; however, various other embodiments may include a single touch screen or a quantity of touch screens greater than two touch screens.

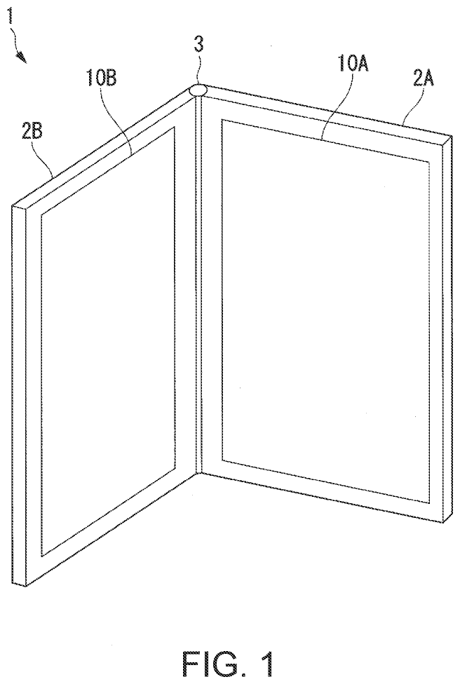

Turning now to the Figures, FIG. 1 is a diagram illustrating one embodiment of an information processing apparatus 1. At least in the embodiment illustrated in FIG. 1, the information processing apparatus 1 includes, among other components, a first chassis 2A and a second chassis 2B, each of which is formed into an approximately rectangular parallelepiped. The first chassis 2A and the second chassis 2B are coupled by a coupling part 3 on both edges thereof. The coupling part 3 includes, for example, a hinge supporting the first chassis 2A and the second chassis 2B in an openable/closable configuration.

The first chassis 2A includes a touch screen 10A and the second chassis 2B includes a touch screen 10B. In the following description, when the touch screens 10A and 10B are distinguished therebetween, either A or B is assigned to the end of the reference numeral, while when the touch screens 10A and 10B are not distinguished therebetween, A and B are omitted. Further, in the following description, an example in which a screen display of the touch screen 10 is a portrait screen display including one of two short sides of the touch screen 10 as an upward orientation of the screen display and the other short side as a downward orientation is taken as an example.

In certain embodiments of the information processing apparatus 1, various modes related to the functions of the touch screen 10 are set. Example modes set in the information processing apparatus 1 include, but are not limited to, a normal mode (e.g., a first mode) and a VPTP mode (e.g., a second mode).

The normal mode includes a mode for causing a predetermined area (e.g., a first area) in a touch panel area with a touch panel of the touch screen 10 formed therein to function as the touch screen. The predetermined area functioning as the touch screen (which may also be called herein, a touch screen area) includes, for example, the whole area of the touch panel area. In the normal mode, for example, it is possible to operate the OSK and the like displayed on the touch screen 10.

The function as the touch screen in the touch screen area is controlled directly by an operating system (OS) according to a predetermined operation. Here, for example, the predetermined operation is a touch operation. Specifically, it is an operation to touch a target displayed on the touch screen 10. In the normal mode, for example, user interfaces (UIs) such as a desktop screen, a taskbar, and the OSK, among other types of UIs that are possible and contemplated herein, are displayed in the touch screen area under the control of the OS. Further, when the OSK is displayed, a UI of a toolbar used to operate an application is displayed in the touch screen area by the application running on the OS. For example, the user can operate the toolbar via an operation medium to perform an operation to switch between the normal mode and the VPTP mode.

The VPTP mode includes a mode that causes a predetermined area (e.g., a second area) in the touch panel area to function as the PTP. The predetermined area functioning as the PTP (which may also be called, a VPTP area) includes, for example, an area in which the VPTP is displayed within the whole area of the touch panel area. Note that an area other than the VPTP area within the whole area of the touch panel area can become the touch screen area.

The function of the PTP in the VPTP area is not controlled directly by the OS according to a predetermined operation. Here, the predetermined operation is a touch operation. Specifically, the predetermined operation can be a gesture operation. In the VPTP mode, for example, control according to a user gesture operation is performed under the control of a control program (e.g., firmware) for the touch screen 10. The control program includes firmware executed by an embedded controller (EC), which may also be called, EC firmware. Further, the VPTP, in certain embodiments, is displayed in the VPTP area under the control of an application. The display under the control of the OS and the display under the control of the application are the same as those in the case of the normal mode.

In various embodiments, the switch between the normal mode and the VPTP mode is controlled by an application. For example, the application instructs the EC firmware to set either one of the modes based on one or more user inputs to the application. At this time, the application instructs the EC firmware to use definition information according to the mode to be set. Here, the definition information is information including information related to hardware (which may also be called, hardware information). The definition information may include various pieces of hardware information, which include, for example, hardware information for the touch screen 10 and hardware information for the PTP. For example, the hardware information includes information on the type and size of hardware and/or the like information. Further, when hardware is virtually displayed on the touch screen 10, the hardware information includes size information indicative of the virtual display size, position information indicative of the virtual display position, display layout information indicative of a layout including other display targets, and the like. The hardware information may also include area setting information related to the settings of areas such as the touch screen area and the VPTP area. Note that the pieces of information included in the definition information is not limited to those in the above examples.

In response to a touch on the touch screen 10 being detected, the EC firmware generates a signal according to the set mode and an area in which the touch is detected and outputs a signal to the OS. In the case in which the touch is detected when the normal mode is set, the EC firmware generates a touch screen signal (e.g., a first signal) indicating that the touch screen 10, as the touch screen, is touched and outputs the signal to the OS. The touch screen signal includes, for example, coordinate information indicative of the definition information of the touch screen 10 and the touch position, among other information that is possible and contemplated herein. When the normal mode is set, since the whole area of the touch panel area is the touch screen area, no touch is detected in the VPTP area.

In the cases in which a touch is detected in the VPTP area when the VPTP mode is set, the EC firmware is configured to generate a VPTP signal (e.g., a second signal) indicating that the touch screen 10, as the PTP, is touched and outputs a signal to the OS. The VPTP signal includes, for example, coordinate information indicative of the definition information of the PTP and the touch position, among other information that is possible and contemplated herein. Alternatively, in the case in which a touch is detected in the touch screen area when the VPTP mode is set, the EC firmware is configured to generate the touch screen signal indicating that the touch screen 10 is touched, as the touch screen and outputs a signal to the OS.

In certain embodiments, the OS that received a signal from the EC firmware is configured to recognizes that the hardware indicated by the definition information included in the received signal is touched. Here, the OS is configured to recognize that the hardware indicated by the definition information is connected to the information processing apparatus 1. For example, in response to receiving the touch screen signal, the OS is configured to recognize that the touch screen 10 is connected to the information processing apparatus 1. Alternatively, in response to receiving the VPTP signal, the OS is configured to recognize that the PTP is connected to the information processing apparatus 1.

In various embodiments, the touch screen 10 is physically connected to the information processing apparatus 1 and the PTP is not physically connected to the information processing apparatus 1. In other words, the OS is configured to recognize hardware not physically connected to the information processing apparatus 1 based on the definition information.

The OS, in various embodiments, is configured to perform a set of operations according to a coordinate position at which a touch is detected on recognized hardware. In response to recognizing the touch screen 10, various embodiments of the OS are configured to perform one or more operations related to the touch screen 10. Alternatively, in response to recognizing the PTP, the OS is configured to perform one or more operations related to the PTP. Thus, various embodiments of the EC firmware can generate a signal according to the set mode and an area at which a touch is detected and output a signal to the OS to control one or more operations of the OS.

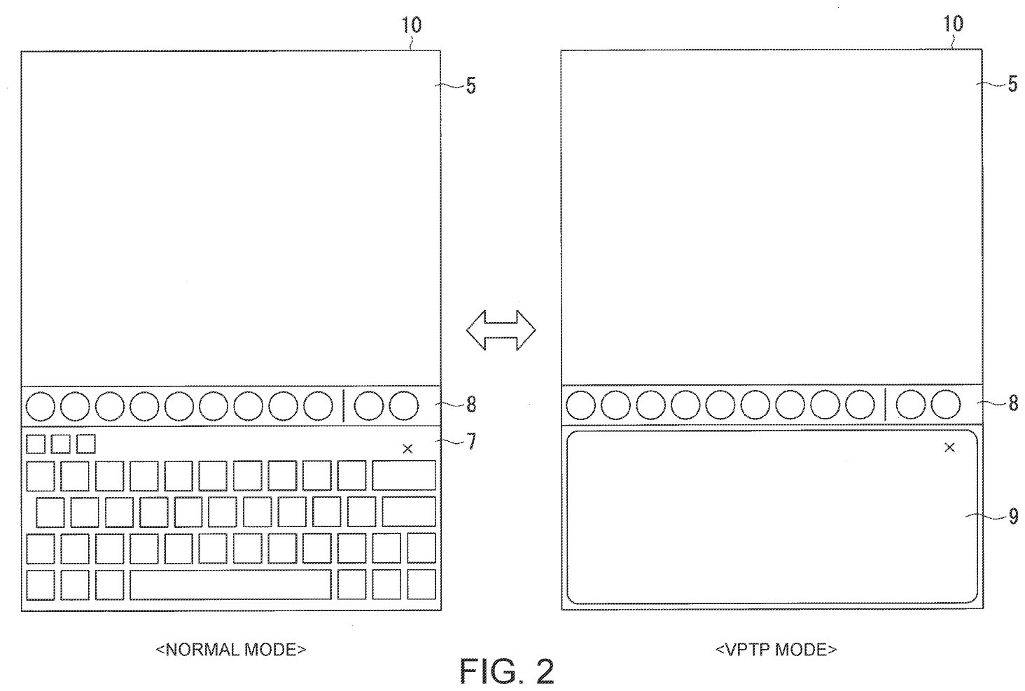

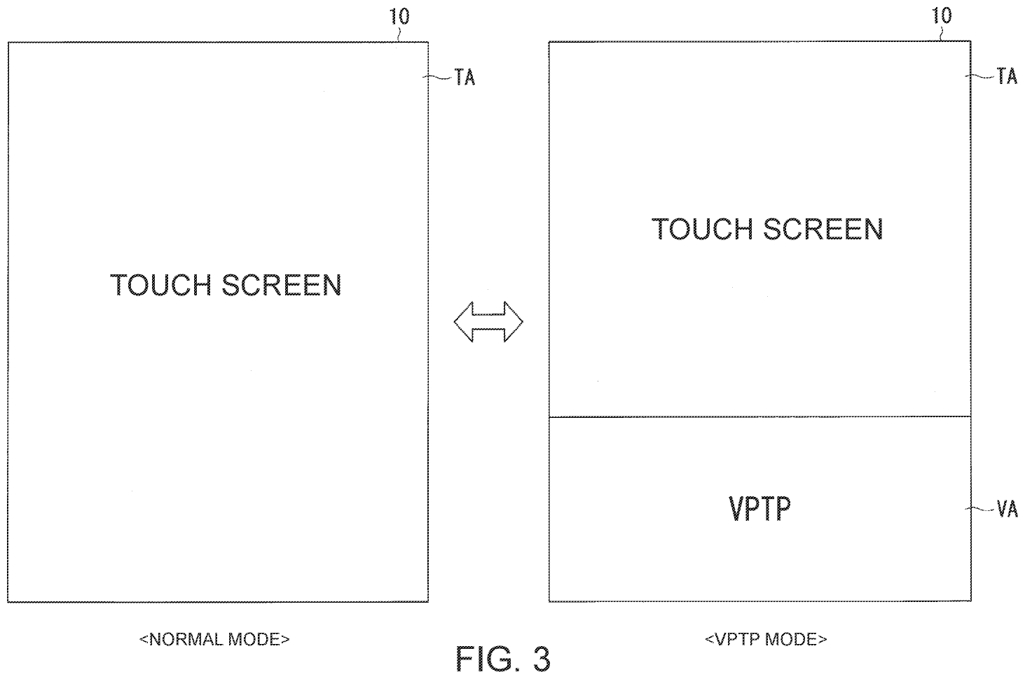

A relationship between the data displayed and the function(s) performed in each mode are described with reference to FIGS. 2 and 3. Specifically, FIG. 2 is a diagram illustrating one embodiment of the display of the touch screen 10 in each operating mode according to one embodiment and FIG. 3 is a diagram illustrating one embodiment of one or more functions of the touch screen 10 in each operating mode.

In the embodiment of a normal mode of operation illustrated on the left side of FIG. 2, a desktop 5, an OSK 7, and a toolbar 8 are displayed on the touch screen 10. Here, as illustrated on the left of FIG. 3, a touch screen area TA in which the desktop 5, the OSK 7, and the toolbar 8 are displayed functions of the touch screen.

Alternatively, in various embodiments of the VPTP mode of operation, the desktop 5, the toolbar 8, and a VPTP 9 are displayed on the touch screen 10, as illustrated on the right side of FIG. 2. Here, as illustrated on the right side of FIG. 3, a touch screen area TA at which the desktop 5 and the toolbar 8 are displayed function(s) as the touch screen and a VPTP area VA at which the VPTP 9 is displayed functions as the PTP.

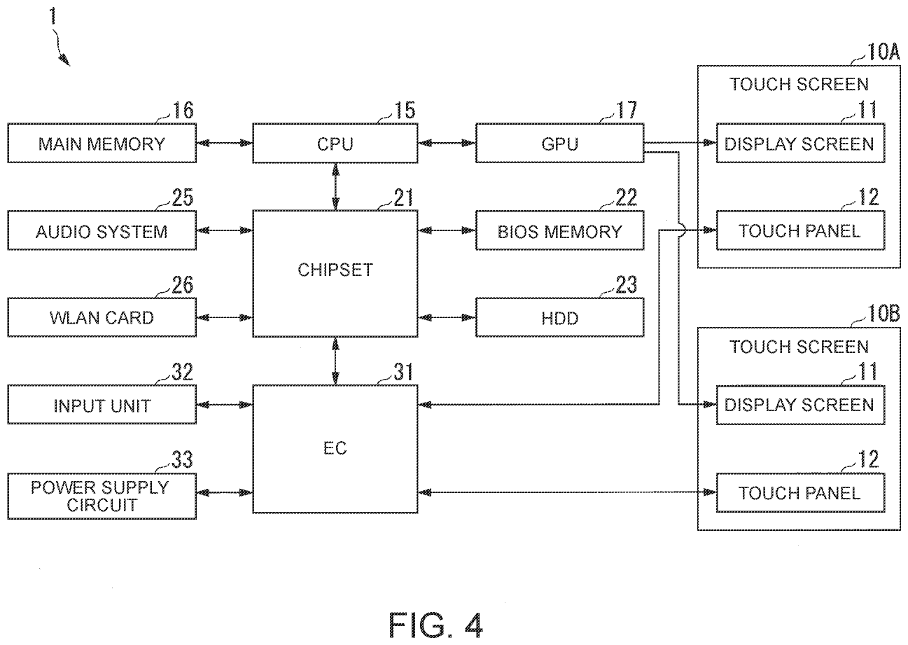

Referring next to FIG. 4, a hardware configuration of the information processing apparatus 1 according to one embodiment is described. Specifically, FIG. 4 is a diagram illustrating an example of the hardware configuration of the information processing apparatus 1 according to one embodiment.

As illustrated in FIG. 4, the information processing apparatus 1 includes, among other components, a touch screen 10A, a touch screen 10B, a central processing unit (CPU) 15, a main memory 16, a graphic processing unit (GPU) 17, and a chipset 21, among other components that are possible and contemplated herein. In some embodiments, the information processing apparatus 1 further includes a basic input output system (BIOS) memory 22, an hard disk drive (HDD) 23, an audio system 25, a wireless local area network (WLAN) card 26, an EC 31, an input unit 32, and a power supply circuit 33, among other components that are possible and contemplated herein.

In various embodiments, the touch screen 10 includes, among other components, a display screen 11 and a touch panel 12. The touch screen 10, in certain embodiments, is configured to display, on the display screen 11, various kinds of information and/or data according to display data converted to video signals and to detect a touch with an operation medium (e.g., one or more fingers of a user and/or a pen, etc., among other types of touch operation mediums) and/or the approach of the operation medium(s) to accept operation input by the operation medium(s) by the touch panel 12.

The display screen 11, in some embodiments, includes a display device, such as a light-emitting diode (LED) display or an organic light-emitting diode (OLED) display, etc., among other types of display devices that are possible and contemplated herein. Note that various embodiments of the display screen 11 may include a configuration that is bendable and/or foldable.

In various embodiments, the touch panel 12 is placed over the display surface of the display screen 11. The touch panel 12, in certain embodiments, is configured detect a touch position and the touch panel 12 may be configured integrally with the display screen 11 to be bendable and/foldable similar to the display screen 11.

The CPU 15, in some embodiments, is configured to execute one or more types of arithmetic processing via a program control to control the operations of the information processing apparatus 1, which can also be referred to as, an information handling device.

The main memory 16, in certain embodiments, includes a writable memory used as one or more reading areas of execution programs of the CPU 15 and/or as working areas to which processing data of the execution programs are written. The main memory 16 includes, in some embodiments, a plurality dynamic random access memory (DRAM) chips, among other types of memory devices that are possible and contemplated herein. In certain embodiments, one or more execution programs include an OS, one or more drivers for one or more corresponding hardware-operating peripheral devices, one or more services/utilities, and/or one or more application programs, etc., among other components that are possible and contemplated herein.

In some embodiments, the GPU 17 is configured to execute image processing under the control of the CPU 15 to generate display data. The GPU 17 is connected to the display screen 11 and is configured to output the generated display data to the display screen 11.

In certain embodiments, the chipset 21 includes, among other components, one or more controllers (e.g., a Universal Serial Bus (USB), a Serial Advanced Technology Attachment (SATA), an Serial Peripheral Interface (SPI) bus, a Peripheral Component Interconnect (PCI) bus, a PCI-Express bus, and an Low Pin Count (LPC) bus) and one or more other devices (e.g., a single device or a plurality of devices) connected to the chipset 21. In FIG. 2, the BIOS memory 22, the HDD 23, the audio system 25, the WLAN card 26, and the EC 31 are connected to the chipset 21 as non-limiting examples of other devices that can be coupled to the chipset 21, among other types of devices and/or other possible combinations of the device(s) that are possible and contemplated herein.

In various embodiments, the BIOS memory 22 is configurable via an electrically re-writable non-volatile memory, such as an Electrically Erasable Programmable Read Only Memory (EEPROM) device or a flash Read Only Memory (ROM) device, etc., among other types of re-writable non-volatile memory that are possible and contemplated herein. The BIOS memory 22 is configured to store the BIOS and system firmware for controlling the EC 31 and the like devices. The system firmware, in various embodiments, includes firmware that is executed by, for example, the CPU 15, which is different from the EC firmware that executed by the EC 31.

In some embodiments, the HDD 23, which is an example of a non-volatile storage device, is configured to store the OS, one or more drivers, one or more services/utilities, and/or one or more application programs, etc., among various other data and/or components that are possible and contemplated herein. In additional or alternative embodiments, the audio system 25 is configured to record, play back, and/or outputs sound data and may include a microphone and/or a speaker coupled to the audio system 25. In further additional or alternative embodiments, the WLAN card 26 is connected to a network via a WLAN and is configured to perform a set of data communication operations.

The EC 31, in various embodiments, includes a one-chip microcomputer that monitors and controls one or more devices (e.g., one or more peripheral devices and/or one or more sensors, etc., among one or more other devices/components and/or one or more other types of components/devices that are possible and contemplated herein) regardless of the system state of the information processing apparatus 1. In certain embodiments, the EC 31 includes a CPU, a ROM device, and a Random Access Memory (RAM) device (not illustrated).

In some embodiments, the EC 31 is configured to operate independently of the CPU 15 and to function as a control unit that mainly manages the operating environment inside the information processing apparatus 1. The EC 31 is further configured to read a control program (e.g., EC firmware) prestored in the ROM and execute processing instructed by one or more commands written in the read control program to implement one or more operational functions. Further, the EC 31, in some embodiments, includes a multi-channel analog-to-digital (A/D) input terminal and a digital-to-analog (D/A) output terminal, a timer, and/or a digital input/output terminal, etc., among other components that are possible and contemplated herein. To the EC 31, for example, the input unit 32, the power supply circuit 33, and/or the like device(s) are connected via the A/D input and D/A output terminals and the EC 31 is configured to control the operation of the input unit 32, the power supply circuit 33, and/or the like device(s).

The input unit 32 includes an input device including, among other components, a power switch, a function switch, and the like to receive inputs. The power supply circuit 33 includes, among other components, a direct current-to-direct current (DC/DC) converter, a charge/discharge unit, a battery unit, an alternating current-to-direct current (AC/DC) adapter, and the like to convert direct current (DC) voltage supplied from the AC/DC adapter or the battery unit into plural voltages required to operate the information processing apparatus 1. Further, the power supply circuit 33 is configured to supply power to each unit of the information processing apparatus 1 under the control of the EC 31.

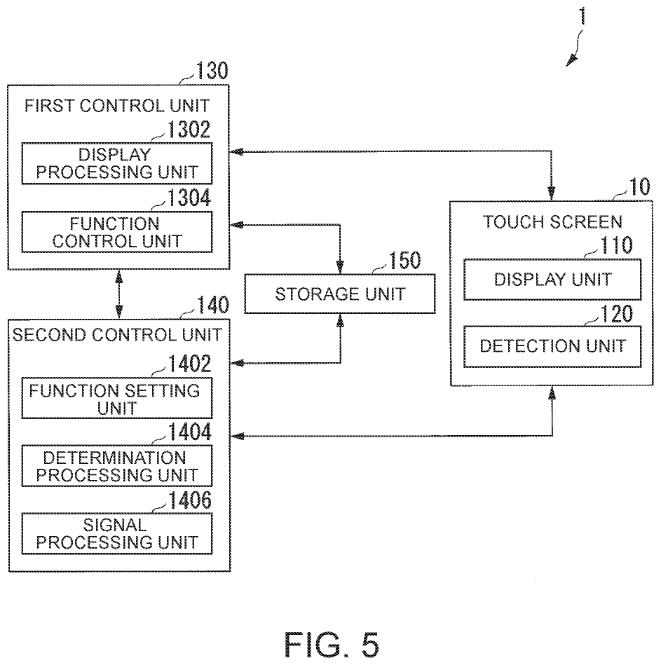

Referring now to FIG. 5, a functional configuration of the information processing apparatus 1 according to various embodiments will be described. FIG. 5 is a block diagram illustrating various embodiments of the functional configuration of the information processing apparatus 1. As illustrated in FIG. 5, the information processing apparatus 1 includes, among other components, a display unit 110, a detection unit 120, a first control unit 130, a second control unit 140, and a storage unit 150.

A display unit 110, in some embodiments, includes a set of functions to display various kinds of information input from the first control unit 130. The display unit 110 includes, for example, the display screen 11 described with reference to FIG. 4, to display, on the display screen 11, one or more UIs, such as the desktop 5, the taskbar, the OSK 7, the toolbar 8, and/or the VPTP 9, among other components that are possible and contemplated herein. Note that the data displayed by the display unit 110 is not limited to the above examples.

A detection unit 120, in various embodiments, includes a set of functions to detect a touch position by an operation medium in the touch panel area. The detection unit 120 includes, for example, the touch panel 12 described with reference to FIG. 4 to cause the touch panel 12 to output the detected touch position to the second control unit 140.

A first control unit 130 includes a set of functions to control the general operation of the information processing apparatus 1. The first control unit 130 is configured to include, for example, the CPU 15, the GPU 17, and/or the like processing units. The function of the first control unit 130 is performed, for example, by the CPU 15 executing system firmware for the BIOS or the OS, or by executing a program such as any of various applications (e.g., an application running on the OS) to boot the system to perform various arithmetic operations, processing, and/or the like operations. To perform the set of functions, the first control unit 130 includes a display processing unit 1302 and a function control unit 1304.

A display processing unit 1302 includes a set of functions to control the display on the display unit 110. The display processing unit 1302 is configured to control the display on the display unit 110 based on, for example, one or more user operations. A non-limiting example of a user operation includes, but is not limited to, an operation to display or hide the OSK 7, an operation to set the normal mode or the VPTP mode, or the like operation(s).

In response to an input operation to display the OSK 7, the display processing unit 1302 is configured to display the OSK 7 on the display unit 110. In response to the OSK 7 being displayed, the display processing unit 1302 is further configured to display the toolbar 8 on the display unit 110. Alternatively, In response to an input operation to hide the OSK 7, the display processing unit 1302 is configured to hide the OSK 7 and the toolbar 8 from the display unit 110.

In response to an input operation to set the VPTP mode in the setting of the normal mode, the display processing unit 1302 is configured to display the VPTP 9 on the display unit 110 based on a set of definition information. For example, the display processing unit 1302 refers to the definition information to acquire information such as size information of the VPTP 9 and position information of the VPTP 9. After acquiring the information, the display processing unit 1302 is configured to generate display data of the VPTP 9 from the acquired size information and cause the display unit 110 to display the generated display data in a position indicated by the position information.

Based on the definition information, the display processing unit 1302 is configured to control a display layout of the OSK 7 displayed in the touch screen area TA and the VPTP 9 displayed in the VPTP area VA. For example, when the size and display position of the VPTP 9 indicated by the definition information are the same as the size and display position of the OSK 7 already displayed, the display processing unit 1302 displays the VPTP 9 in the display area of the OSK 7. At this time, the display processing unit 1302 displays the VPTP 9 after hiding the OSK 7 from the display unit 110. Note that the display processing unit 1302 may also display the VPTP 9 in such a manner to overlay the VPTP 9 on the OSK 7 without hiding the OSK 7 from the display unit 110. Thus, the display processing unit 1302 can secure an area other than that of the VPTP 9 more widely on the display unit 110 than that in the case where the VPTP 9 and the OSK 7 are displayed in different areas.

Alternatively, in response to an input operation to set the normal mode in the setting of the VPTP mode, the display processing unit 1302 is configured to hide the VPTP 9 from the display unit 110. At this time, the display processing unit 1302 redisplays the OSK 7 on the display unit 110, which enables the user to operate the OSK 7 again. Note that, when the VPTP 9 is overlaid on the OSK 7 in the setting of the VPTP mode, the OSK 7 appears by hiding the VPTP 9. Thus, when the operation to set the normal mode is input in the state where the VPTP 9 is overlaid on the OSK 7, the display processing unit 1302 does not have to perform processing for redisplaying the OSK 7 on the display unit 110.

Note that processing for displaying or hiding the OSK 7 is executed, for example, by the OS. Further, processing for displaying or hiding the toolbar 8 is executed, for example, by an application. Further, processing for displaying or hiding the VPTP is executed, for example, by the same or a different application.

A function control unit 1304 includes a set of functions configured to control the function of the touch screen 10. For example, the function control unit 1304 controls the mode to be set on the touch screen 10. Specifically, the function control unit 1304 controls the setting of either the normal mode or the VPTP mode based on a user operation.

In response to an input operation to switch to the VPTP mode in the setting of the normal mode, the function control unit 1304 is configured to determine to cause a function setting unit 1402 to set the VPTP mode on the touch screen 10. Here, the function control unit 1304 is configured to cause the function setting unit 1402 to set, as the VPTP area VA, an area in which the VPTP 9 in the touch panel area is displayed. Specifically, the function control unit 1304 refers to the definition information to acquire size information and position information of the VPTP 9. After acquiring the information, based on the size information and the position information, the function control unit 1304 sets, as the VPTP area VA, the area where the VPTP 9 is displayed. Further, the function control unit 1304 is configured to set an area other than the VPTP area VA as the touch screen area TA.

Alternatively, in response to an input operation to switch to the normal mode in the setting of the VPTP mode, the function control unit 1304 is configured to cause the function setting unit 1402 to set the normal mode on the touch screen 10. Here, the function control unit 1304 is configured to cause the function setting unit 1402 to set the whole area of the touch panel area as the touch screen area TA.

As described above, the function control unit 1304 can switch between the normal mode and the VPTP mode based on a user operation to set the display on the touch screen 10. Further, in the setting of the VPTP mode, the function control unit 1304 can set the VPTP area VA in an area in which the VPTP 9 is displayed on the display unit 110 to function a predetermined area in the touch panel area as the PTP.

A second control unit 140 includes a set of functions is configured to control the general operation of various devices (e.g., one or more peripheral devices, one or more sensors, and/or one or more of the like devices). The second control unit 140 is configured to include, for example, the EC 31. The function of the second control unit 140 is performed, for example, by the EC firmware executed by the EC 31 performing various arithmetic operations, processing, and the like operations. To perform the function(s), the second control unit 140 includes a function setting unit 1402, a determination processing unit 1404, and a signal processing unit 1406. Note that the function(s) of the function setting unit 1402, the determination processing unit 1404, and the signal processing unit 1406 are also implemented by the EC firmware.

A function setting unit 1402 includes a set of functions to configure settings related to the functions of the touch screen 10. The function setting unit 1402 is configured to set a mode for the touch screen 10. For example, the function setting unit 1402 sets either the normal mode or the VPTP mode for the touch screen 10 based on an instruction from the function control unit 1304. Specifically, in response to receiving an instruction to set the normal mode from the function control unit 1304, the function setting unit 1402 is configured to set the normal mode for the touch screen 10. Alternatively, in response receiving an instruction to set the VPTP mode from the function control unit 1304, the function setting unit 1402 is configured to set the VPTP mode for the touch screen 10.

Further, the function setting unit 1402 is configured to set an area in the touch panel area of the touch screen 10. For example, the function setting unit 1402 sets at least either the touch screen area TA or the VPTP area VA in the touch panel area based on an instruction from the function control unit 1304. Specifically, in response to receiving an instruction to set the touch screen area TA from the function control unit 1304, the function setting unit 1402 is configured to generate the touch screen area TA based on the definition information of the touch screen. After generating the touch screen area TA, the function setting unit 1402 is configured to set the generated touch screen area TA on the touch screen 10. Further, in response to receiving an instruction to set the touch screen area TA and the VPTP area VA from the function control unit 1304, the function setting unit 1402 is configured to generate the VPTP area VA based on the definition information of the PTP. After generating the VPTP area VA, the function setting unit 1402 is configured to set the generated VPTP area VA on the touch screen 10. At this time, the function setting unit 1402 overlays the generated VPTP area VA on the touch screen area TA already set in the touch panel area.

A determination processing unit 1404 includes a set of functions to determine an area operated by an operation medium. For example, the determination processing unit 1404 is configured to determine an area operated by an operation medium based on the touch position of the operation medium detected by the detection unit 120. Specifically, the determination processing unit 1404 is configured to first determine an area including the touch position detected by the detection unit 120. In response to the touch position being included in the touch screen area TA, the determination processing unit 1404 is configured to determine that the touch screen area TA is being operated. Alternatively, in response to the touch position being included in the VPTP area VA, the determination processing unit 1404 is configured to determine that the VPTP area VA is being operated. Subsequently, the determination processing unit 1404 outputs the determination result to the signal processing unit 1406.

A signal processing unit 1406 includes a set of functions is configured to generate a signal for controlling the operation of the OS and outputting the generated signal to the OS. For example, based on the determination result input from the determination processing unit 1404, the signal processing unit 1406 generates a signal including definition information corresponding to an area in which the touch position is detected and outputs the generated signal to the OS.

In response to the determination result indicating that the touch position is detected in the touch screen area TA, the signal processing unit 1406 is configured to generate a touch screen signal including the definition information of the touch screen 10 and output the generated touch screen signal to the OS. Thus, the signal processing unit 1406 can cause the OS to recognize that the touch screen 10 is operated as the touch screen and to perform a set of operations corresponding to a touch screen.

Alternatively, in response to the determination result indicating that the touch position is detected in the VPTP area VA, the signal processing unit 1406 is configured to generate a VPTP signal including the definition information of the PTP and output the VPTP signal to the OS. Thus, the signal processing unit 1406 can cause the OS to recognize that the touch screen 10 is being operated as a PTP and to perform a set of operations corresponding to a PTP.

In setting the normal mode, the touch screen area TA is set over the whole area of the touch panel area. Therefore, the signal processing unit 1406 is configured to generate the touch screen signal and output the generated touch screen signal to the OS wherever a touch is detected in the touch panel area.

In setting the VPTP mode, the VPTP area VA is overlaid on a partial area of the touch screen area TA. Therefore, in response to a touch being detected in the touch screen area TA, the signal processing unit 1406 is configured to generate the touch screen signal similar to the setting of the normal mode and output the generated touch screen signal to the OS. Alternatively, in response to a touch being detected in the VPTP area VA, the signal processing unit 1406 is configured to generate the VPTP signal and output the generated VPTP signal to the OS.

Upon generation of a signal, for example, the signal processing unit 1406 is configured to change the definition information included in the signal to change the signal to be output to the OS. Specifically, it is presumed that a touch is detected in the VPTP area VA after the touch screen signal is output. Here, the signal processing unit 1406 changes the definition information of the touch screen 10 included in the touch screen signal to the definition information of the PTP and the touch screen signal is changed to the VPTP signal. Thus, the signal processing unit 1406 is configured to generate a signal indicating that a partial area of the touch panel area is touched as a signal indicating that the PTP is touched.

Note that the touch screen signal and the VPTP signal are generated by the EC firmware of the touch screen 10 and output to the OS. Thus, one or more operation related to the touch screen 10 by the OS is controlled by the EC firmware of the touch screen 10.

A storage unit 150 includes a set of functions is configured to store various kinds of information and/or data. The storage unit 150 includes, among other components, the main memory 16, the BIOS memory 22, the HDD 23, and the ROM, RAM, and the like of the EC 31. For example, the storage unit 150 is configured to store software, such as the OS and various applications, various firmware such as the system firmware and the EC firmware, and/or the definition information, among other data that is possible and contemplated herein. The storage unit 150 according to various embodiments is configured to store at least one definition information indicating, as an example, that the screen display of the touch screen 10 is set as a portrait screen display and that the VPTP 9 is displayed in an area where the OSK 7 was displayed.

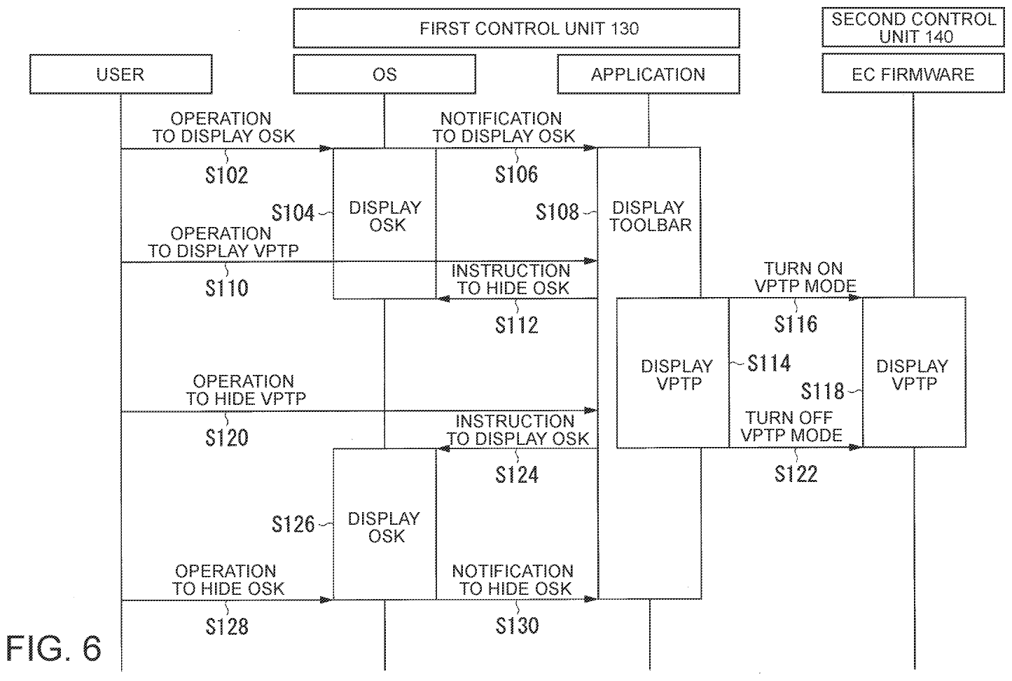

Various embodiments of a functional configuration of the information processing apparatus 1 are described above. Referring next to FIG. 6 through FIG. 11, flow diagrams of various embodiments of processing performed in the information processing apparatus 1 are described.

FIG. 6 is a flow diagram illustrating one embodiment of processing performed in the information processing apparatus 1. In the following, as illustrated in FIG. 6, processing is based on user operations in the OS and an application executed by the first control unit 130 of the information processing apparatus 1 and in the EC firmware executed by the second control unit 140 will be described, respectively.

A user first inputs an operation to display the OSK 7 to the information processing apparatus 1 (Block S102). This operation is input to the OS via the touch screen 10. The OS to which the operation is input displays the OSK 7 on the touch screen 10 (Block S104). After displaying the OSK 7, the OS outputs, to the application, a notification indicating that the OSK 7 is displayed (Block S106). The application that received the notification displays the toolbar 8 on the touch screen 10 (Block S108).

The user inputs an operation to display the VPTP 9 to the information processing apparatus 1 (Block S110). This operation is input to the application via the toolbar 8 displayed on the touch screen 10. The application to which the operation is input outputs, to the OS, an instruction to hide the OSK 7 (Block S112). The OS that received the instruction hides the OSK 7 from the touch screen 10. Subsequently, the application displays the VPTP 9 in the area where the OSK 7 was displayed on the touch screen 10 (Block S114). Next, the application outputs, to the EC firmware, an instruction to turn ON the VPTP mode of the touch screen 10 (Block S116). The EC firmware that received the instruction sets the VPTP mode for the touch screen 10 (Block S118).

Further, the user inputs an operation to hide the VPTP 9 to the information processing apparatus 1 (Block S120). This operation is input to the application via the toolbar 8 displayed on the touch screen 10. The application to which the operation is input outputs, to the EC firmware, an instruction to turn OFF the VPTP mode of the touch screen 10 to hide the VPTP 9 from the touch screen 10 (Block S122). The EC firmware that received the instruction turns OFF the VPTP mode. Next, the application outputs, to the OS, an instruction to display the OSK 7 (Block S124). The OS that received the instruction displays the OSK 7 on the touch screen 10 (Block S126).

In addition, the user inputs an operation to hide the OSK 7 to the information processing apparatus 1 (Block S128). This operation is input to the OS via the touch screen 10. The OS to which the operation is input hides the OSK 7 from the touch screen 10. Further, the OS outputs, to the application, a notification indicating that the OSK 7 is to be hidden (Block S130). The application that received the notification hides the toolbar 8 from the touch screen 10.

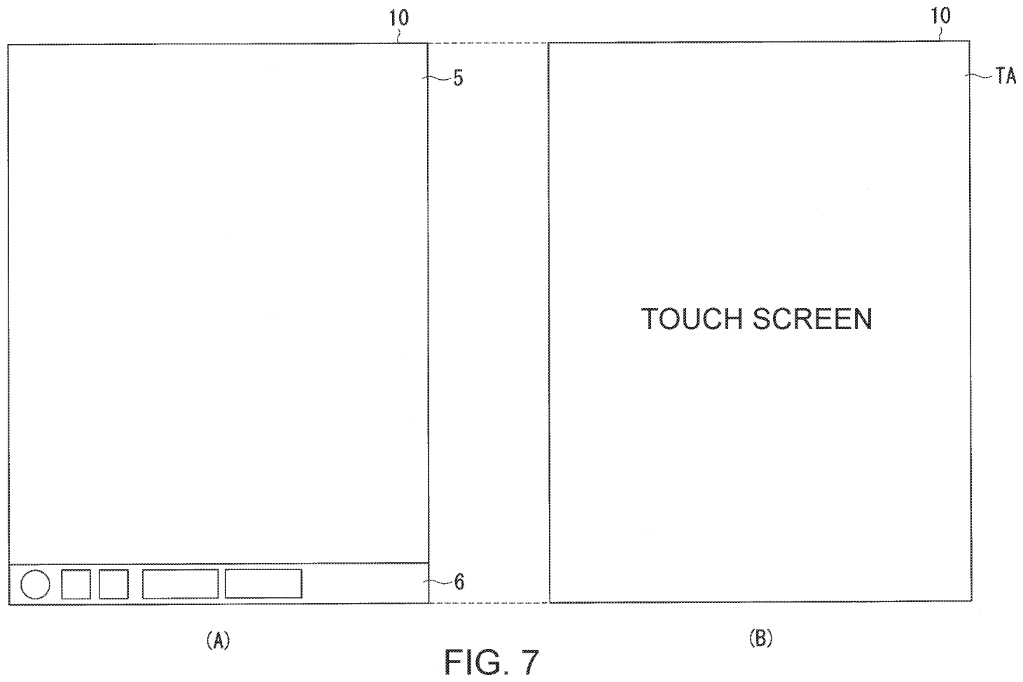

Below, examples of transitions of the display and function of the touch screen 10 will be described with reference to FIG. 7 through FIG. 10.

FIG. 7 is a diagram illustrating one embodiment of the display and function of the touch screen 10 upon initial display. (A) on the left of FIG. 7 illustrates a display example and (B) on the right of FIG. 7 illustrates a function example. Upon initial display (e.g., before execution of Block S102), for example, the desktop 5 and a taskbar 6 are displayed on the touch screen 10 as illustrated at (A) in FIG. 7. Here, as illustrated at (B) in FIG. 7, the touch screen area TA is set over the whole area of the touch screen 10 (e.g., a touch panel area) and the touch screen area TA functions as the touch screen.

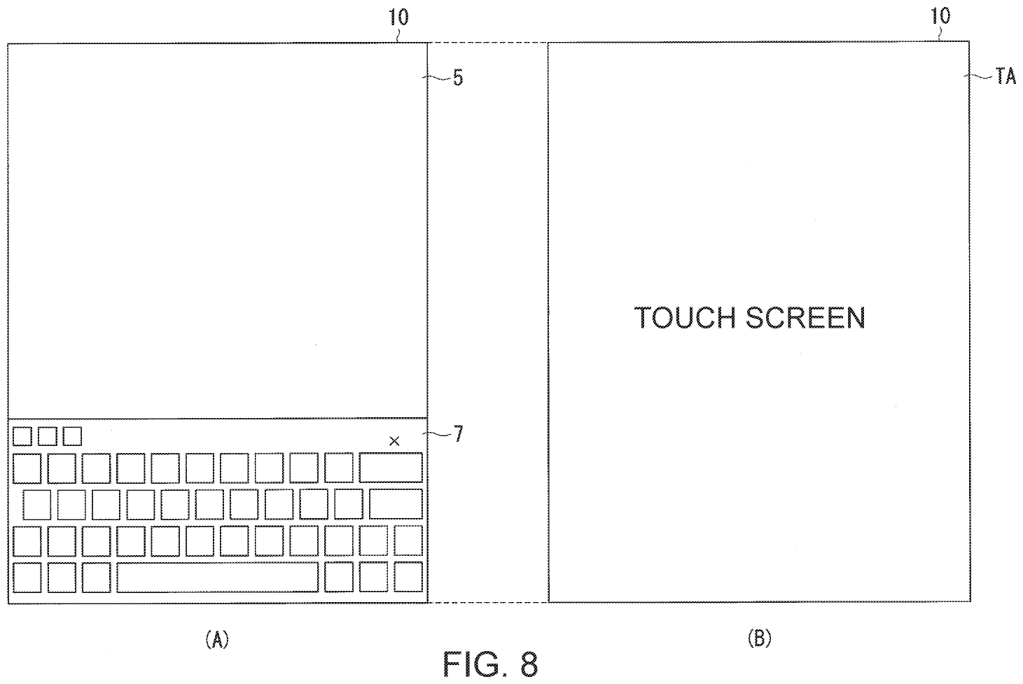

FIG. 8 is a diagram illustrating the display and function of the touch screen 10 during the display of the OSK 7 according to one embodiment. (A) on the left of FIG. 8 illustrates a display example and (B) on the right of FIG. 8 illustrates a function example. During the display of the OSK 7 (e.g., during the execution of Blocks S104 through S106), for example, the desktop 5 and the OSK 7 are displayed on the touch screen 10 as illustrated at (A) in FIG. 8. Here, as illustrated at (B) in FIG. 8, the touch screen area TA is set over the whole area of the touch screen 10 and the touch screen area TA functions as the touch screen.

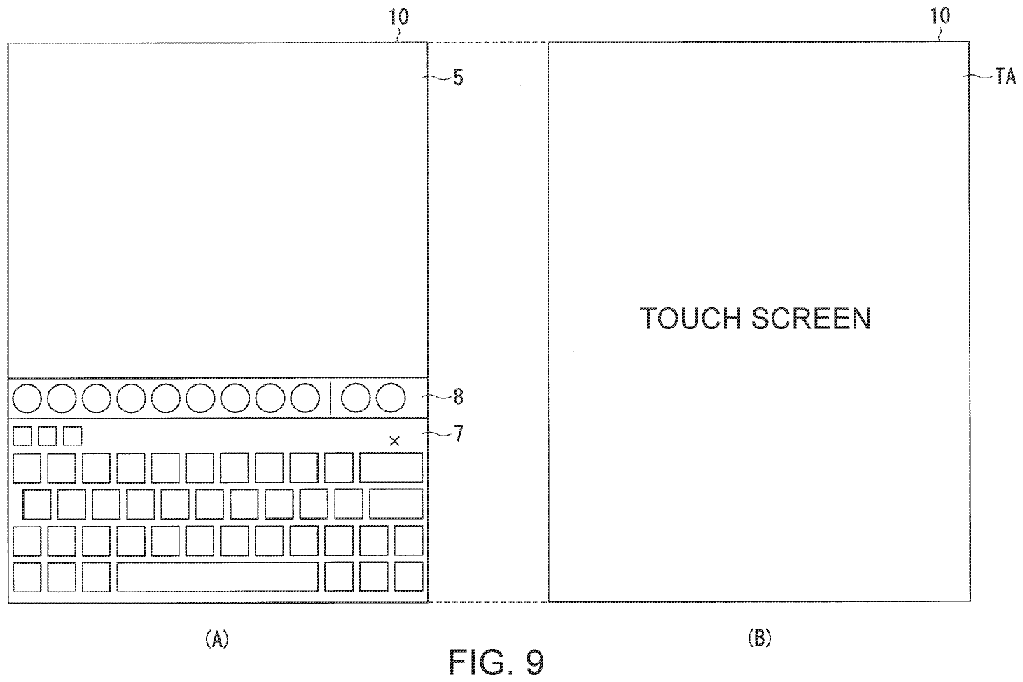

FIG. 9 is a diagram illustrating the display and function of the touch screen 10 during the display of the toolbar 8 according to one embodiment. (A) on the left of FIG. 9 illustrates a display example and (B) on the right of FIG. 9 illustrates a function example. During the display of the toolbar 8 (e.g., during the execution of Blocks S108 through S112, and Blocks S124 through S130), for example, the desktop 5, the OSK 7, and the toolbar 8 are displayed on the touch screen 10 as illustrated at (A) in FIG. 9. Here, as illustrated at (B) in FIG. 9, the touch screen area TA is set over the whole area of the touch screen 10 and the touch screen area TA functions as the touch screen.

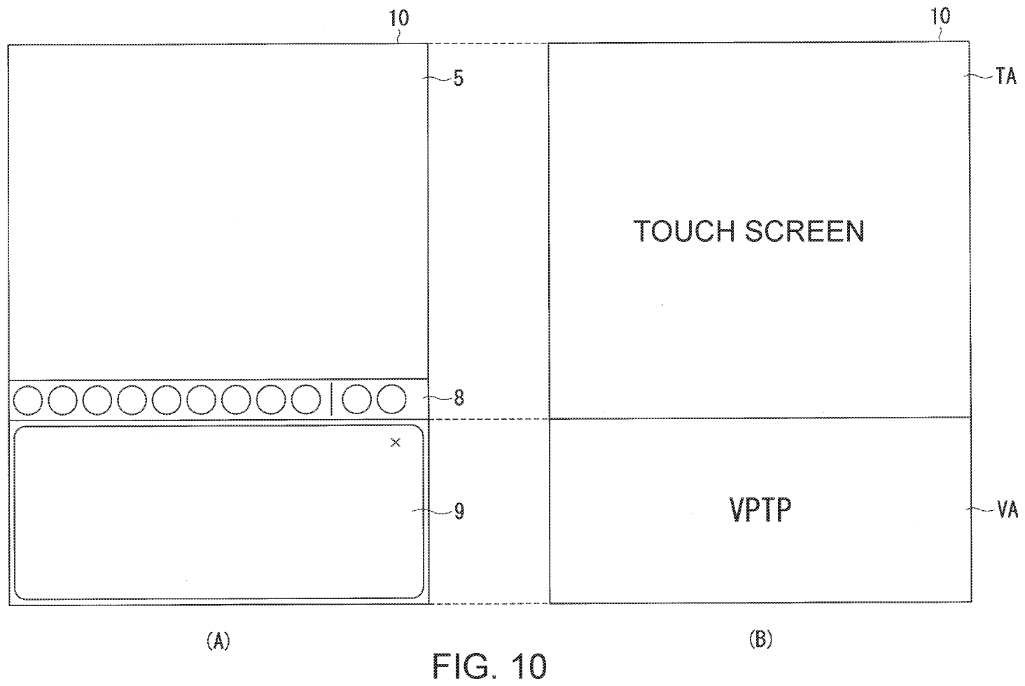

FIG. 10 is a diagram illustrating one embodiment of the display and function of the touch screen 10 during the display of the VPTP 9. (A) on the left of FIG. 10 illustrates a display example and (B) on the right of FIG. 10 illustrates a function example. During the display of the VPTP 9 (e.g., during the execution of Blocks S114 through S122), for example, the desktop 5, the toolbar 8, and the VPTP 9 are displayed on the touch screen 10 as illustrated at (A) in FIG. 10. Here, as illustrated at (B) in FIG. 10, the touch screen area TA is set in an area in which the desktop 5 and the toolbar 8 are displayed on the touch screen 10 and the touch screen area TA functions as the touch screen. Further, the VPTP area VA is displayed in an area where the VPTP 9 is displayed on the touch screen 10 and the VPTP area VA functions as the PTP.

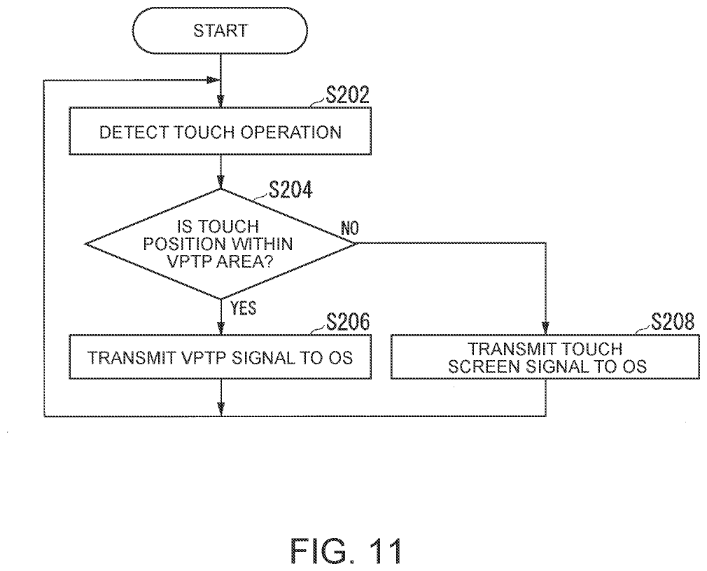

FIG. 11 is a flowchart illustrating a flow of processing in the second control unit 140 according to one embodiment. As illustrated in FIG. 11, the second control unit 140 detects a touch operation on the display unit 110 with an operation medium (Block S202). Next, the second control unit 140 determines whether the touch position of the detected touch operation is within the VPTP area VA (Block S204).

In response to the touch position being within the VPTP area VA (e.g., a “YES” in Block S204), the second control unit 140 causes the EC firmware to transmit the VPTP signal to the OS (Block S206). Alternatively, in response to the touch position not being within the VPTP area VA (e.g., a “NO” in Block S204), the second control unit 140 causes the EC firmware to transmit the touch screen signal to the OS (Block S208). After the signal is transmitted, the second control unit 140 repeats the above-described processing each time a touch operation is detected.

As described herein, the touch screen 10 of the information processing apparatus 1 according to various embodiments includes the display unit 110 and the touch panel 12 (e.g., a detection unit 120) that detects the touch position where the display unit 110 is touched. Further, the information processing apparatus 1 includes firmware configured to generate the VPTP area, which is not directly controlled by the OS, in the touch panel area where the touch panel is formed. The firmware overlays the generated VPTP area on the touch screen area as the touch screen directly controlled by the OS according to a predetermined operation(s). Further, in response to the VPTP area being touched, the firmware is configured to generate the VPTP signal indicating that the PTP is touched.

The VPTP signal generated by the firmware is output to the OS by the firmware. Based on the received VPTP signal, the OS performs a set of operations related to the PTP. According to such a configuration, in response to a touch with an operation medium being detected, the information processing apparatus 1 can cause a predetermined area on the touch screen 10 to function as a PTP that allows various gesture operations in addition to the operation of a mouse cursor. Thus, the information processing apparatus 1 can improve user experiences with the touch screen 10.

The various embodiments of the present technology are not limited to the embodiments described above. That is, various modifications of one or more embodiments are described below. Note that each of the modifications may be applied individually to one or more embodiments or a combination of modifications may be applied to the one or more embodiments. Further, each modification may be applied instead of the configuration described in an embodiment or applied additionally to the configuration described in an embodiment described above.

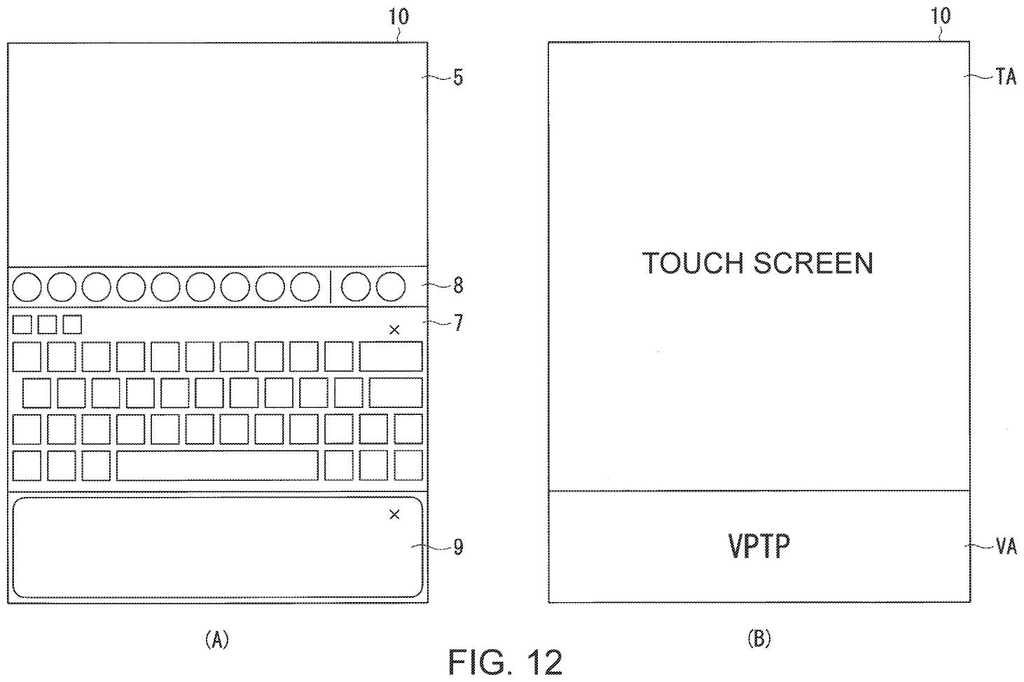

Referring to FIG. 12, one embodiment of a first modification is described with reference thereto. FIG. 12 is a diagram illustrating one embodiment of the display and function of the touch screen 10 in the first modification. (A) on the left of FIG. 12 illustrates a display example and (B) on the right of FIG. 12 illustrates a function example.

In the embodiment shown in FIG. 12, the example in which the VPTP 9 may be overlaid on the OSK 7 is described, but the display processing unit 1302 may also display the VPTP 9 without being overlaid on the OSK 7. For example, as illustrated at (A) in FIG. 12, the desktop 5, the OSK 7, the toolbar 8, and the VPTP 9 are displayed on the touch screen 10. Further, the VPTP 9 is displayed in an area different from the OSK 7 without being overlaid on the OSK 7. Here, as illustrated at (B) in FIG. 12, the touch screen area TA is set in an area in which the desktop 5, the OSK 7, and the toolbar 8 of the touch screen 10 are displayed, and the touch screen area TA functions as the touch screen. Further, the VPTP area VA is set in an area where the VPTP 9 of the touch screen 10 is displayed and the VPTP area VA functions as the PTP.

Since both the OSK 7 and the VPTP 9 are displayed on the touch screen 10, the user can save effort in switching to the display when using the OSK 7 or the VPTP 9. Thus, the information processing apparatus 1 can improve user experiences with the touch screen. When this modification is carried out, it is presumed that the storage unit 150 stores definition information including display layout information indicative of the display layout of (A) in FIG. 12 and area setting information indicative of the area settings of (B) in FIG. 12.

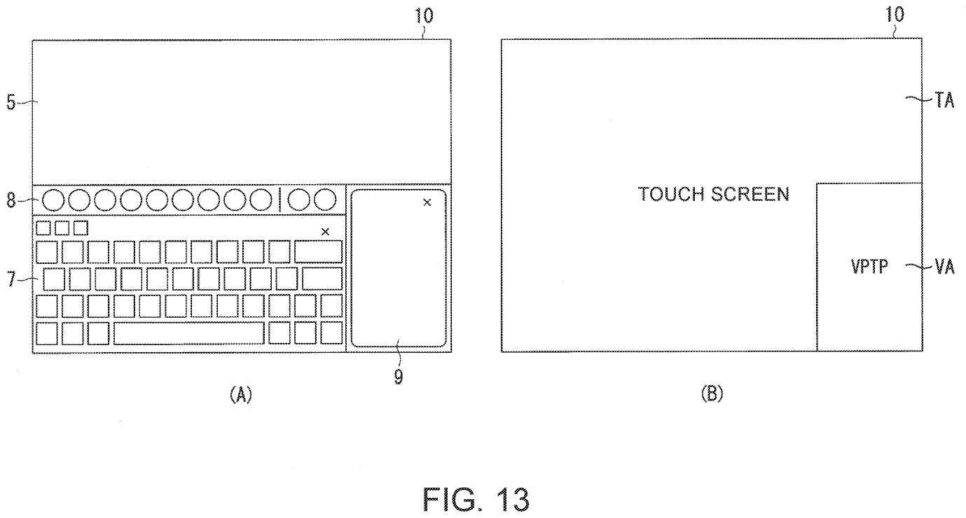

Referring next to FIG. 13, one embodiment of a second modification is described with reference thereto. FIG. 13 is a diagram illustrating one embodiment of the display and function of the touch screen 10 in the second modification. (A) on the left of FIG. 13 illustrates a display example and (B) on the right of FIG. 13 illustrates a function example.

In the embodiment shown in FIG. 13, the example in which the screen display on the touch screen 10 is the portrait screen display is described, but the present technology is not limited to this embodiment. For example, the screen display on the touch screen 10 may also be a landscape screen display including one of two long sides of the touch screen 10 as an upward orientation of the screen display and the other long side as a downward orientation of the screen display.

In the case of a landscape screen display, for example, the desktop 5, the OSK 7, the toolbar 8, and the VPTP 9 are displayed on the touch screen 10 as illustrated at (A) in FIG. 13. Here, as illustrated at (B) in FIG. 13, the touch screen area TA is set in an area in which the desktop 5, the OSK 7 and the toolbar 8 of the touch screen 10 are displayed and the touch screen area TA functions as the touch screen. Further, the VPTP area VA is set in an area where the VPTP 9 of the touch screen 10 is displayed and the VPTP area VA functions as the PTP. Accordingly, the touch screen 10 can display the VPTP 9 even in the case of the landscape screen display.

The user can use the VPTP 9 even when holding the information processing apparatus 1 in a manner to provide a landscape screen display. Therefore, the information processing apparatus 1 can improve user experiences with the touch screen. When this modification is carried out, it is presumed that the storage unit 150 stores definition information including display layout information indicative of the display layout of (A) in FIG. 13 and area setting information indicative of the area settings of (B) in FIG. 13.

Further, one embodiment of a third modification is described below. In the above-described embodiment in which the storage unit 150 stores one piece of definition information is described, but the present technology is not limited to this embodiment. For example, the storage unit 150 may also store a plurality of pieces of definition information. An example of a plurality pieces of definition information includes a plurality pieces of definition information different in display layout, such as definition information for realizing the display and function illustrated in FIG. 2 and FIG. 3, definition information for realizing the display and function illustrated in FIG. 12, and definition information for realizing the display and function illustrated in FIG. 13.

As such, the information processing apparatus 1 can provide a context-sensitive variety of displays on the touch screen 10. For example, it is presumed that the storage unit 150 stores definition information related to the portrait screen display and definition information related to the landscape screen display. Here, in response to the user operating the information processing apparatus 1 while holding the information processing apparatus 1 in such a manner as to set one of two short sides of the touch screen 10 as an upward orientation of the screen display and the other short side as a downward orientation of the screen display, the screen display of the touch screen 10 is a portrait screen display. In this state, in response to the user rotating the information processing apparatus 1 to set one of two long sides of the touch screen 10 as the upward orientation of the screen display and the other long side as the downward orientation, the screen display of the touch screen 10 changes to a landscape screen display.

Further, the plurality pieces of definition information may be a plurality pieces of definition information different in PTP hardware information, which can cause the information processing apparatus 1 to display, on the touch screen 10, VPTPs 9 according to various standards. Since the storage unit 150 stores the plurality pieces of definition information, the touch screen 10 can display the VPTP 9 according to the orientation of the information processing apparatus 1 and the user can use the VPTP 9 regardless of the orientation of the information processing apparatus 1. Further, the touch screen 10 can display VPTPs 9 according to various standards and the user can select a VPTP 9 that suits the user. Accordingly, the information processing apparatus 1 can improve user experiences with the touch screen.

Various modification embodiments are described above. Note that the information processing apparatus 1 in the above-described embodiments may be realized by a computer. Here, it may be realized by recording a program for implementing this function on a computer-readable recording medium, reading the program recorded on this recording medium into a computer system, and executing the program. Note that the “computer system” described here can include the OS and hardware, such as one or more peripheral devices. Further, the “computer-readable recording medium” means a storage medium such as, for example, a flexible disk, a magneto-optical disk, a ROM, a portable medium like a CD-ROM, or a hard disk incorporated in the computer system, among other storage mediums that are possible and contemplated herein. Further, the “computer-readable recording medium” may include a communication line in which the program is dynamically held for a short time and through which the program is transmitted, such as a network like the Internet or a telephone line, and a medium on which the program is held for a given length of time, such as a volatile memory inside a computer system as a server or a client when the program is transmitted. The above-mentioned program may also be configured to implement some of the functions described above, the program may be able to implement the above-described functions in combination with one or more programs already recorded in the computer system, or the program may be implemented by using a programmable logic device such as a Field Programmable Gate Array (FPGA).

While the various embodiments have been described in detail above with reference to the accompanying drawings, the specific configurations are not limited to that described above, and various design changes can be made without departing from the scope of this invention. Further, although the above embodiments are described with respect to a situation in which the information processing apparatus is a laptop PC, the various embodiments are not limited thereto. That is, an information processing apparatus (or information handling device) may also include, but is not limited to, a desktop PC, a tablet PC, a personal digital assistance (PDA), or other similar devices/systems. Moreover, an input device is not limited to the pressure-sensitive touchpad 6, but may be, for example, an input device of a game console or an input device provided in an Internet of Things (IoT) device, and the input device can be widely applied to any device that functions as a user interface.

While the present technology has been described in each form, the technical scope of the present technology is not limited to the scope of the above-described aspects and various combinations, changes, or improvements can be added without departing from the scope of the technology. The forms to which the combinations, changes, or improvements are added shall also be included in the technical scope of the present technology.

Embodiments may be practiced in other specific forms. The described embodiments are to be considered in all respects only as illustrative and not restrictive. The scope of the technology is, therefore, indicated by the appended claims rather than by the foregoing description. All changes which come within the meaning and range of equivalency of the claims are to be embraced within their scope.

1. An apparatus, comprising:
a display unit;
a touch panel configured to detect a touch position of a touch on the display unit; and
an information handling device configured to:
generate, in a touch panel area where the touch panel is formed, a second area that not controlled by an operating system and that is overlaid on a first area of a touch screen controlled by the operating system according to a predetermined operation, and
generate a signal indicating that a precision touch pad is touched in response to the second area being touched.

2. The apparatus of claim 1, further comprising:
a storage unit configured to store definition information of hardware related to the touch screen and the precision touch pad different from the touch screen,
wherein the information handling device is further configured to:
generate the signal to include the definition information corresponding to an area where the touch position is detected, and
output the signal to the operating system.

3. The apparatus of claim 2, wherein:
in response to the touch position being detected in the first area, the information handling device is configured to:
generate a first signal including the definition information of the touch screen, and
output the first signal to the operating system; and
in response to the touch position being detected in the second area, the information handling device is configured to:
generate a second signal including the definition information of the precision touch pad, and
output the second signal to the operating system.

4. The apparatus of claim 2, further comprising:
a function control unit,
wherein the function control unit is configured to perform a set of controls to set, based on a user operation, a first mode to set the first area in the touch panel area or a second mode to set the first area and the second area in the touch panel area.

5. The apparatus of claim 4, further comprising:
a display processing unit,
wherein:
in response to the second mode being set, the display processing unit is configured to display a virtual precision touch pad, as a virtual type of the precision touch pad, on the display unit based on the definition information, and
the information handling device is configured to generate the second area in an area where the virtual precision touch pad is displayed.

6. The apparatus of claim 5, wherein:
the display processing unit is configured to control a display layout of a screen keyboard displayed in the first area based on the definition information, and
the virtual precision touch pad is displayed in the second area.

7. The apparatus of claim 6, wherein the display processing unit is configured to overlay display of the virtual precision touch pad on the screen keyboard.

8. The apparatus of claim 6, wherein the display processing unit is configured to display the virtual precision touch pad without being overlaid on the screen keyboard.

9. A method, comprising:
detecting, by a processor of an information handling device, a touch position of a touch on a display unit;
generating a touch panel area where the touch panel is formed, a second area that is not controlled by an operating system and that is overlaid on a first area of a touch screen controlled by the operating system according to a predetermined operation; and
generating a signal indicating that a precision touch pad is touched in response to the second area being touched.

10. The method of claim 9, further comprising:
generating the signal to include definition information of hardware related to the touch screen and the precision touch pad different from the touch screen corresponding to an area where the touch position is detected; and
outputting the signal to the operating system.

11. The method of claim 10, further comprising:
in response to the touch position being detected in the first area, generating a first signal including the definition information of the touch screen and outputting the first signal to the operating system; and
in response to the touch position being detected in the second area, generating a second signal including the definition information of the precision touch pad and outputting the second signal to the operating system.

12. The method of claim 10, further comprising:
performing a set of controls to set, based on a user operation, a first mode to set the first area in the touch panel area or to set a second mode to set the first area and the second area in the touch panel area.

13. The method of claim 12, further comprising:
in response to the second mode being set, displaying a virtual precision touch pad, by a display processing unit, as a virtual type of the precision touch pad on the display unit based on the definition information; and
generating the second area in an area where the virtual precision touch pad is displayed.

14. The method of claim 13, further comprising:
controlling a display layout of a screen keyboard displayed in the first area based on the definition information; and
displaying the virtual precision touch pad in the second area.

15. The method of claim 14, further comprising:
overlaying display of the virtual precision touch pad on the screen keyboard.

16. The method of claim 14, further comprising:
displaying the virtual precision touch pad without being overlaid on the screen keyboard.

17. A computer program product comprising a computer-readable storage medium including program instructions embodied therewith, the program instructions executable by a processor to cause the processor to:
detect a touch position of a touch on a display unit;
generate a touch panel area where the touch panel is formed, a second area that is not controlled by an operating system and that is overlaid on a first area of a touch screen controlled by the operating system according to a predetermined operation; and
generate a signal indicating that a precision touch pad is touched in response to the second area being touched.

18. The computer program product of claim 17, wherein the processor is further configured to:
generate the signal to include definition information of hardware related to the touch screen and the precision touch pad different from the touch screen corresponding to an area where the touch position is detected; and
output the signal to the operating system.

19. The computer program product of claim 18, wherein the processor is further configured to:
in response to the touch position being detected in the first area, generate a first signal including the definition information of the touch screen and outputting the first signal to the operating system; and
in response to the touch position being detected in the second area, generate a second signal including the definition information of the precision touch pad and outputting the second signal to the operating system.

20. The computer program product of claim 19, wherein the processor is further configured to:
perform a set of controls to set, based on a user operation, a first mode to set the first area in the touch panel area or to set a second mode to set the first area and the second area in the touch panel area; and
in response to the second mode being set:
display a virtual precision touch pad as a virtual type of the precision touch pad on the display unit based on the definition information, and
generate the second area in an area where the virtual precision touch pad is displayed.
